(19) United States
(12) Patent Application Publication
(10) Pub. No.: US 2016/0295200 A1
(43) Pub. Date: Oct. 6, 2016

(54) GENERATON OF IMAGES FOR AN AUTOSTEREOSCOPIC MULTI-VIEW DISPLAY

(71) Applicant: KONINKLIJKE PHILIPS N.V., Eindhoven (NL)

(72) Inventor: Wilhelmus Hendrikus Alfonsus BRULS, EINDHOVEN (NL)

(21) Appl. No.: 15/035,524

(22) PCT Filed: Oct. 17, 2014
(86) PCT No.: PCT/EP2014/072313

§ 371 Date: May 10, 2016

(30) Foreign Application Priority Data
Nov. 20, 2013 (EP) 13193687.4

(51) Int. Cl. H04N 13/04; H04N 13/00

(52) U.S. Cl. CPC H04N 13/0402; H04N 13/0014; H04N 13/0022; H04N 13/0484; H04N 2013/0081

(57) ABSTRACT

An autosteroscopic multi-view display comprises a first image generator (807) which generates first images for views of a first group of contiguous views of the views of the display. A second image generator (809) generates second images for views of a second group of contiguous views and a third image generator (811) generates a third image for at least one view of a third group of contiguous views. The first images correspond to a right eye viewing angle and the second images correspond to a left eye viewing angle of a scene. The third image corresponds to a viewing angle between the right eye viewing angle and the left eye viewing angle. The use of a transitional group of views corresponding to intermediate viewing angles may substantially reduce cross talk and ghosting effects. It may in combination with viewer tracking provide a practical and high performance autostereoscopic multi-view display allowing increased depth levels.

### FIELD OF THE INVENTION

The invention relates to generation of images for an autosteroscopic multi-view display, and in particular, but not exclusively, to generation of images for using a multi-view display as a single viewer display.

### BACKGROUND OF THE INVENTION

Three dimensional displays are receiving increasing interest, and significant research in how to provide three dimensional perception to a viewer is undertaken. Three dimensional (3D) displays add a third dimension to the viewing experience by providing a viewer's two eyes with different views of the scene being watched. This can be achieved by having the user wear glasses to separate two views that are displayed. However, as this is relatively inconvenient to the user, it is in many scenarios desirable to use autostereoscopic displays that directly generate different views and projects them to the eyes of the user. Indeed, for some time, various companies have actively been developing auto-stereoscopic displays suitable for rendering three-dimensional imagery. Autostereoscopic devices can present viewers with a 3D impression without the need for special headgear and/or glasses.

Autostereoscopic displays generally provide different views for different viewing angles. In this manner, a first image can be generated for the left eye and a second image for the right eye of a viewer. By displaying appropriate images, i.e. appropriate from the viewpoint of the left and right eye respectively, it is possible to convey a 3D impression to the viewer.

Autostereoscopic displays tend to use means, such as lenticular lenses or barrier masks, to separate views and to send them in different directions such that they individually reach the user's eyes. For stereo displays, two views are required but most autostereoscopic displays typically utilize more views (such as e.g. nine views).

In order to fulfill the desire for 3D image effects, content is created to include data that describes 3D aspects of the captured scene. For example, for computer generated graphics, a three dimensional model can be developed and used to calculate the image from a given viewing position. Such an approach is for example frequently used for computer games which provide a three dimensional effect.

As another example, video content, such as films or television programs, are increasingly generated to include some 3D information. Such information can be captured using dedicated 3D cameras that capture two simultaneous images from slightly offset camera positions thereby directly generating stereo images.

Typically, autostereoscopic displays produce “cones” of views where each cone contains two or often more views that correspond to different viewing angles of a scene. The viewing angle difference between adjacent (or ins some cases further displaced) views are generated to correspond to the viewing angle difference between a user's right and left eye. Accordingly, a viewer whose left and right eye see two appropriate views will perceive a three dimensional effect. An example of such a system wherein nine different views are generated in a viewing cone is illustrated in FIG. 1.

Many autostereoscopic displays are capable of producing a large number of views. For example, autostereoscopic displays which produce nine views are not uncommon. Such displays are e.g. suitable for multi-viewer scenarios where several viewers can watch the display at the same time and all experience the three dimensional effect. Displays with even higher number of views have also been developed, including for example displays that can provide 28 different views. Such displays may often use relatively narrow view cones such that the viewer's eyes will receive light from a plurality of views simultaneously. Also, the left and right eyes will typically be positioned in views that are not adjacent (as in the example of FIG. 1).

However, although the described auto-stereoscopic displays provide a very advantageous three dimensional experience, it has some associated disadvantages. For example, auto-stereoscopic displays tend to be highly sensitive to the viewer's position and therefore tends to be less suitable for dynamic scenarios wherein it cannot be guaranteed that a person is at a very specific location. Specifically, the correct three dimensional perception is highly dependent on the user being located such that the viewer's eyes perceive views that correspond to correct viewing angles. However, in some situations, the user's eyes may not be located to receive suitable image views and therefore some auto-stereoscopic display applications and scenarios may have a tendency to confuse the human visual system leading to an uncomfortable feeling for the viewer which may possibly lead to some discomfort or even potentially to headaches etc.

A particular disadvantage of many multi-view autostereoscopic displays is that there may be a relatively high degree of cross-talk between views, and this may degrade the perceived three dimensional effect and the perceived image quality.

In order to reduce the cross talk perceived by the viewer, it has been proposed to group the views of the display into two groups with all views of one group displaying the same left eye image and all views of the other group displaying the same right eye image. Thus, it has been proposed to allocate only left eye and right eye images/views to the individual multi-view inputs of an auto-stereoscopic multi-view 3D display.

For example, for a 28 view multi-view autostereoscopic display, views number 1 through 14 may display the same left eye view (L) and views number 15 through 28 may display the same right view (R) of a stereo image. The arrangement may be demonstrated by (where the view number is written vertically):
0000000001111111111222222222
1234567890123456789012345678
LLLLLLLLLLLLLLRRRRRRRRRRR

However, although such an approach may reduce the cross talk between individual views (as they show the same image), it also results in a significant amount of crosstalk between the views used for respectively the left eye view and the right eye view. For example, there will be substantial cross talk from view 14 (containing an L view) to view 17 (containing a R view); or from view 15 (containing a R view) to view 12 (containing a L view). FIG. 2 illustrates an example of cross talk that may be experienced in such an approach. In the figure, the x-axis shows the offset in number of views from the border between view 14 and 15 and the y-axis shows the relative cross talk value.

As a typical example, a viewer's eyes may be separated by around 10 views for a 28 view multi-view display. With the viewer's eyes being centralized on the transition between the left and right views (i.e. between views 14 and 15), the amount of cross talk will typically be acceptable (as illustrated in FIG. 3). However, if there is even a small offset from the center, this will typically result in a significant amount of crosstalk in one of the eyes (as illustrated by FIG. 4).

It is therefore critical in such systems that the user is positioned very accurately with respect to the display, and indeed, it may be required that the user sits very still. In order to address this issue, it has been proposed to use an eyes/face detector/tracker to adapt the direction of the cone of views such that the user is centrally positioned with respect to this cone. However, in order to achieve acceptable performance, it is typically necessary for the tracker to be highly accurate and fast. Indeed, typically, the tracker must be able to track user movements substantially instantly and with an accuracy of a few millimeters. Such a strict requirement in terms of accuracy and latency makes such tracking systems of limited practical use and indeed makes it an infeasible approach in many scenarios.

Hence, an improved approach for driving autostereoscopic displays would be advantageous and in particular, an approach allowing increased flexibility, reduced complexity, increased image quality, improved three dimensional perception, stronger three depth effects, reduced discomfort, reduced cross talk, reduced intensity variations and/or increased performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for generating images for an autosteroscopic multi-view display arranged to display a plurality of views; the apparatus comprising: a first image generator for generating first images for views of a first group of contiguous views of the plurality of views, the first images corresponding to a right eye viewing angle; a second image generator for generating second images for views of a second group of contiguous views of the plurality of views, the second images corresponding to a left eye viewing angle; a third image generator for generating a third image for at least one view of a third group of contiguous views of the plurality of views, the third group of contiguous views comprising views between the first group of contiguous views and the second group of contiguous views; and wherein the third image corresponds to a viewing angle which is between the right eye viewing angle and the left eye viewing angle.

The approach may allow improved rendering of three dimensional images from a multi-view autostereoscopic display. The approach may in particular allow improved rendering when the multi-view autostereoscopic display is used for a single viewer.

The approach may specifically in many embodiments reduce the perceived cross-talk substantially. The approach in many scenarios reduces cross talk while maintaining a very low degree of intensity variations, and indeed in many embodiments the reduction of cross talk is achieved without introducing any additional intensity variations.

The reduced cross talk may substantially reduce the requirement for the user to be positioned optimally. Thus, the approach may allow a user a higher degree of freedom in head movements, and may in embodiments using head or eye trackers substantially reduce the requirements for the tracking performance.

The approach may provide an improved overall perceived image quality when the images are rendered for the multi-view autostereoscopic display.

In traditional autostereoscopic multi-view displays, the degradations and particularly the cross talk caused by the difference of the images of different views are typically of such significance that the disparity, and thus three dimensional effect, is kept at a low level. Indeed, typical depth ranges for autostereoscopic multi-view displays are typically in the order of around 20-30 cm in order to not introduce degradations that are perceived to reduce image quality or even to potentially cause some discomfort to the viewer. Using the approach of the invention a much high depth effect can often be provided. Indeed, it has been found that depth ranges of more than one meter can be achieved without causing significant image degradation (in particular ghosting) or discomfort to users. Thus, the approach may allow for much more intense depth modes than can be achieved by conventional displays.

In some embodiments, the multi-view autostereoscopic display may comprise the apparatus for generating the images for the multi-view autostereoscopic display. In some embodiments, the apparatus may be external to the multi-view autostereoscopic display. For example, the apparatus may be comprised in a device, such as a set-top box. Thus, in some embodiments, the apparatus may comprise an output for generating a drive signal for the multi-view autostereoscopic display, the drive signal comprising the first images, the second images, and the at least third image. In some embodiments, the drive signal may comprise an image for each view of the multi-view autostereoscopic display. The images may be represented in any suitable form in the drive signal, including e.g. providing some images as common images for a plurality of views, as encoded or unencoded images, directly as drive signals for pixels of the display, etc.

The first images, second images, and third image are all views of the same scene. The views are at different viewing angles. Indeed, typically images are generated of the same scene for all views of the autostereoscopic multi-view display. The images may correspond to different viewing angles of the scene, with the first images corresponding to a viewing angle (or viewpoint) for a right eye, the second images corresponding to a viewing angle (or viewpoint) for a left eye. Thus, the first images when perceived by the right eye and the second images when perceived by the left eye will provide a three dimensional representation of the scene. The third image will correspond to a viewing angle in between that of the first and second images, i.e. to a viewing angle between the left eye viewing angle and the right eye viewing angle.

The first images may be substantially identical images. Indeed, in most embodiments, the same image is used for all views of the first group of contiguous views, i.e. the first images may be the same image. In some embodiments, minor differences, typically substantially imperceptible differences, may occur between the first images.

The second images may be substantially identical images. Indeed, in most embodiments, the same image is used for all views of the second group of contiguous views, i.e. the second images may be the same image. In some embodiments, minor differences, typically substantially imperceptible differences, may occur between the second images.

In some embodiments, at least some of the images may be partial images. The full image for one eye may in some embodiments be provided by a combination of plurality of views.

Specifically, in some embodiments, the first images may be different partial images of the same full image (which is an image for the viewer's right eye). Similarly, in some embodiments, the second images may be different partial images of the same full image (which is an image for the viewer's left eye).

In many embodiments, the total number of views of the display may not be less than nine views, or even 18 or 24 views in many embodiments. The number of views in the first group of contiguous views is often advantageously at least three and at least often five, or seven views.

At least one of the first group of contiguous views and the second group of contiguous views comprises a plurality of views, and typically both the first and second group of contiguous views comprises a plurality of views. The number of views in the second group of contiguous views is often advantageously at least three and often at least five or seven views. The number of views in the third group of contiguous views is often advantageously at least three and often at least five or seven views.

The third group of contiguous views specifically only comprises views that are between the views of the first and second groups of contiguous views, and may specifically comprise all views between the first and second groups of contiguous views.

The term “viewing angles” in relation to images generally reflects the viewing angles of the images relative to the scene represented by the images and not the viewing angle of the viewer relative to the display. Thus, the right eye viewing angle for the first images represents the viewing angle for the right eye of a viewer and the left eye viewing angle for the second images represents the viewing angle for the left eye of a viewer at the position for which the images are generated or captured. This does not reflect the position of a user relative to the display.

In accordance with an optional feature of the invention, the apparatus further comprises a receiver for receiving a three dimensional image, and wherein the first image generator is arranged to generate the first images from the three dimensional image, the second image generator is arranged to generate the second images from the three dimensional image; and the third image generator is arranged to generate the third image from the three dimensional image.

This may allow an efficient and practical approach for driving an autostereoscopic multi-view display based on image signals suitable for distribution.

The three dimensional image may be any image comprising a form of depth information whether provided by direct depth data or by indirect depth data such as disparities between images corresponding to different viewing angles of a scene. For example, the three dimensional image may specifically comprise a single image and depth information, images of the same scene from different viewing angles/viewpoints, occlusion information or any combination thereof.

The three dimensional image may specifically be an image of a video sequence.

In accordance with an optional feature of the invention, the three dimensional image is a stereo image comprising a left eye image and a right eye image and the first image generator is arranged to generate the first images to correspond to the right eye image, the second image generator is arranged to generate the second images to correspond to the left eye image; and the third image generator is arranged to generate the third image by view point shifting applied to at least one of the left eye image and the right eye image.

The approach may provide a particularly suitable approach for driving an autostereoscopic multi-view display based on stereo images that are images directly provided for the respective eyes of a person (and which may be generated for use with conventional three dimensional display techniques using glasses).

The approach allows a substantially increased depth effect to be provided from an autostereoscopic multi-view display thereby allowing such stereo images (which typically have a high degree of depth) to be used, and indeed often to be used directly.

In accordance with an optional feature of the invention, the apparatus further comprises a disparity adapter arranged to adapt disparities between the left eye image and the right eye image prior to the generation of the first images, the second images and the third image.

The adapter may specifically reduce the disparities between the left eye image and the right eye image prior to the images being used to generate the images for the autostereoscopic multi-view display. Specifically, the modified left and right images may be used directly as the first images and the second images thereby directly providing the depth effect. The depth effect may be adjusted by adjusting disparities between the images and may specifically be used to generate images having the desired depth effect in view of the enhanced depth range possible with the autostereoscopic multi-view display.

In accordance with an optional feature of the invention, the three dimensional image is a single viewpoint image with associated depth information and the first image generator is arranged to generate the first images by view point shifting of the single viewpoint image based on the depth information, the second image generator is arranged to generate the second images by view point shifting of the single viewpoint image based on the depth information, the view point shifting of the second images being in an opposite direction of the view point shifting of the first images; and wherein the third image generator is arranged to generate the third image to correspond to the single viewpoint image.

This may provide a particularly advantageous driving of an autostereoscopic multi-view display in many embodiments and scenarios.

In accordance with an optional feature of the invention, the third group of contiguous views comprises a plurality of views, and the third image generator is arranged to generate images for all views of the third group of contiguous views to correspond to viewing angles between the right eye viewing angle and the left eye viewing angle.

This may provide improved performance in many embodiments and may in particular reduce cross talk and possibly intensity variations thereby for example allowing an increased depth effect to be provided.

The number of views in the third group of contiguous views may in many embodiments advantageously be no less than 2, 3, 5 or even 7.

In accordance with an optional feature of the invention, the third image generator is arranged to generate images for the plurality of views of the third group of contiguous views as at least part of the third image.

In some embodiments, the same intermediate viewing angle image may be used for all views of the third group of contiguous views. This may in many scenarios provide desirable performance while maintaining low complexity and computational resource demand. In many embodiments, images for all views of the third group of contiguous views are generated from the third image, i.e. all views within the third contiguous group show at least part of the third image.

In accordance with an optional feature of the invention, the third image generator is arranged to generate images for the plurality of views of the third contiguous group to correspond to viewing angles having a monotonic relationship to a distance of the views to the first group of contiguous views.

The third group of contiguous views may present images that correspond to viewing angles between the right eye viewing angle and the left eye viewing angle but with different viewing angles which gradually change from towards the right eye viewing angle to towards the left eye viewing angle. The viewing angles may change monotonically in order of how close they respectively are to the first group of contiguous views and the second group of contiguous views.

In accordance with an optional feature of the invention, the relationship is a linear relationship.

This may provide an improved user experience in many scenarios, and may in many scenarios provide the least perceived cross talk for offsets of the viewer from the ideal position.

In accordance with an optional feature of the invention, the apparatus further comprises a viewer position tracking unit arranged to generate a user viewing angle estimate; and an adaptor arranged to adapt a direction of at least one viewing cone formed by the plurality of views in response to the user viewing angle estimate.

The invention may allow a much improved three dimensional user experience wherein a viewer position tracking unit may control the rendered image such that the transitional region of the third group of contiguous views are optimally directed towards the user. Due to the driving of the third group of contiguous views a substantially better integration with user tracking can be achieved. For example, more inaccurate tracking approaches may be used to provide improved performance.

In accordance with an optional feature of the invention, all views of the plurality of views of the multi view display belong to one of the first group of contiguous views, the second group of contiguous views, and the third group of contiguous views.

This may provide improved performance in many embodiments.

In accordance with an optional feature of the invention, the third image generator is arranged to generate different partial images for at least some views of the third group of contiguous views.

This may provide improved performance and/or facilitated implementation in many embodiments. Indeed, the approach of driving an autostereoscopic multi-view display is particularly suited to increasing the effective resolution by using partial images for different views.

The partial images may correspond to different parts of an image corresponding to one viewing angle which is between the right eye viewing angle and the left eye viewing angle.

According to an aspect of the invention there is provided autosteroscopic multi-view display arranged to display a plurality of views, the display comprising: a first image generator for generating first images for views of a first group of contiguous views of the plurality of views, the first images corresponding to a right eye viewing angle; a second image generator for generating second images for views of a second group of contiguous views of the plurality of views, the second images corresponding to a left eye viewing angle; a third image generator for generating a third image for at least one view of a third group of contiguous views of the plurality of views, the third group of contiguous views comprising views between the first group of contiguous views and the second group of contiguous views; and wherein the third image corresponds to a viewing angle which is between the right eye viewing angle and the left eye viewing angle.

According to an aspect of the invention there is provided a method of generating images for an autosteroscopic multi-view display arranged to display a plurality of views, the apparatus comprising: generating first images for views of a first group of contiguous views of the plurality of views, the first images corresponding to a right eye viewing angle; generating second images for views of a second group of contiguous views of the plurality of views, the second images corresponding to a left eye viewing angle; generating a third image for at least one view of a third group of contiguous views of the plurality of views, the third group of contiguous views comprising views between the first group of contiguous views and the second group of contiguous views; and wherein the third image corresponds to a viewing angle which is between the right eye viewing angle and the left eye viewing angle.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of an autostereoscopic multi-view display with nine view;

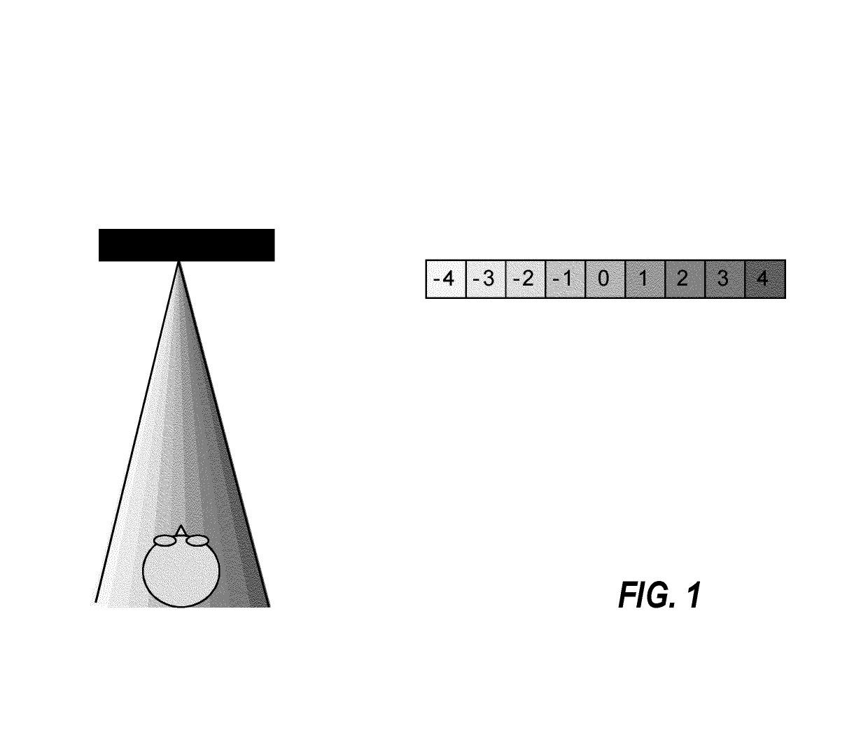

FIG. 2 illustrates an example of cross talk for an autostereoscopic multi-view display;

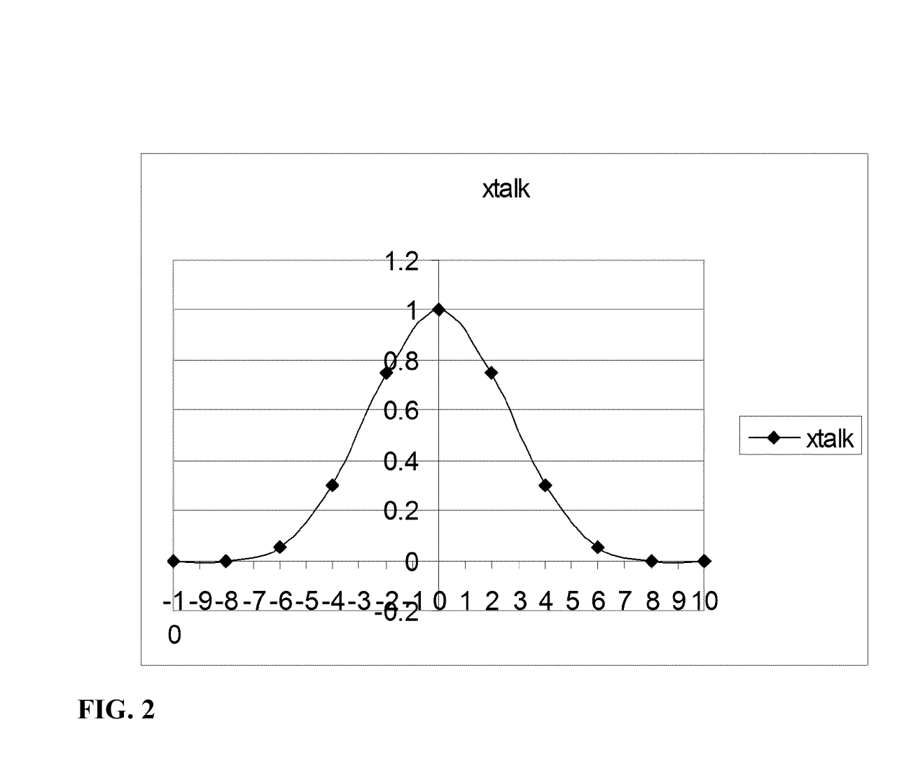

FIG. 3 illustrates an example of cross talk for an autostereoscopic multi-view display;

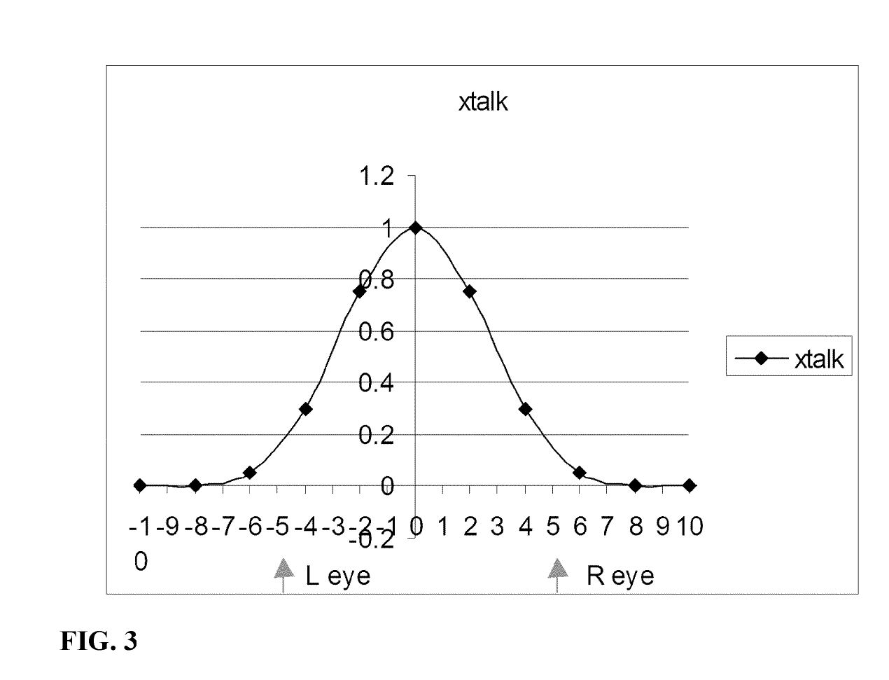

FIG. 4 illustrates an example of cross talk for an autostereoscopic multi-view display;

FIG. 5 illustrates an example of an autostereoscopic multi-view display with nine views;

FIG. 6 illustrates an example of allocation of viewing angles for an autostereoscopic multi-view display;

FIG. 7 illustrates an example of allocation of viewing angles for an autostereoscopic multi-view display;

FIG. 8 illustrates an example of an autostereoscopic multi-view display in accordance with some embodiments of the invention;

FIG. 9 illustrates an example of allocation of viewing angles for an autostereoscopic multi-view display;

FIG. 10 illustrates an example of allocation of viewing angles for an autostereoscopic multi-view display;

FIG. 11 illustrates an example of allocation of viewing angles for an autostereoscopic multi-view display;

FIG. 12 illustrates an example of an autostereoscopic multi-view display in accordance with some embodiments of the invention; and

FIG. 13 illustrates an example of allocations of viewing angles for an autostereoscopic multi-view display.

### DETAILED DESCRIPTION OF SOME EMBODIMENTS OF THE INVENTION

The following description focuses on embodiments of the invention applicable to the use of an autostereoscopic multi-view display for providing a three dimensional image to a single viewer. However, it will be appreciated that the invention is not limited to this application.

Autostereoscopic multi-view displays have been developed in order to provide glasses free three dimensional image rendering. Such displays may generate a plurality of views that project images corresponding to different viewing angles for a scene. A user will be positioned such that his eyes receives different views thus resulting in different images corresponding to different viewing angles being perceived by the user's eyes. This may be used to provide a three dimensional perception.

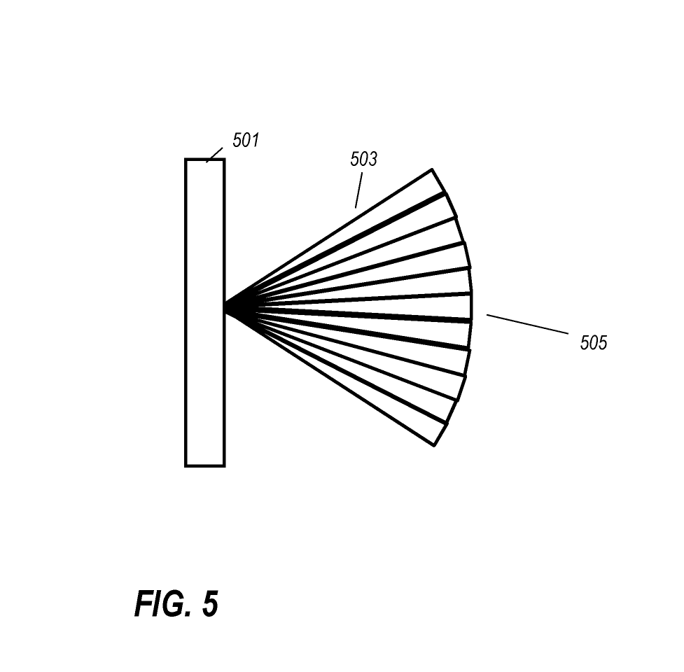

An exemplary autostereoscopic multi-view display 501 is shown in FIG. 5. The figure illustrates how the autostereoscopic multi-view display 501 of the example generates an overall viewing cone 503 which comprises a plurality of views 505 each of which may present a different image (or possibly partial image). The figure illustrates an overall viewing cone comprising nine views but in other embodiments, other number of views may be generated by the autostereoscopic multi-view display 501. Indeed, autostereoscopic multi-view displays with significantly more views are being developed, including displays of typically 28 views.

The different views are typically generated using e.g. lenticular screens or barrier masks on top of pixel layers as will be well known to the skilled person. In most displays, this results in multiple viewing cones adjacent to each other. E.g. next to the viewing cone 503 of FIG. 5 will be replicas/repetitions of the viewing cone (i.e. the views will be repeated).

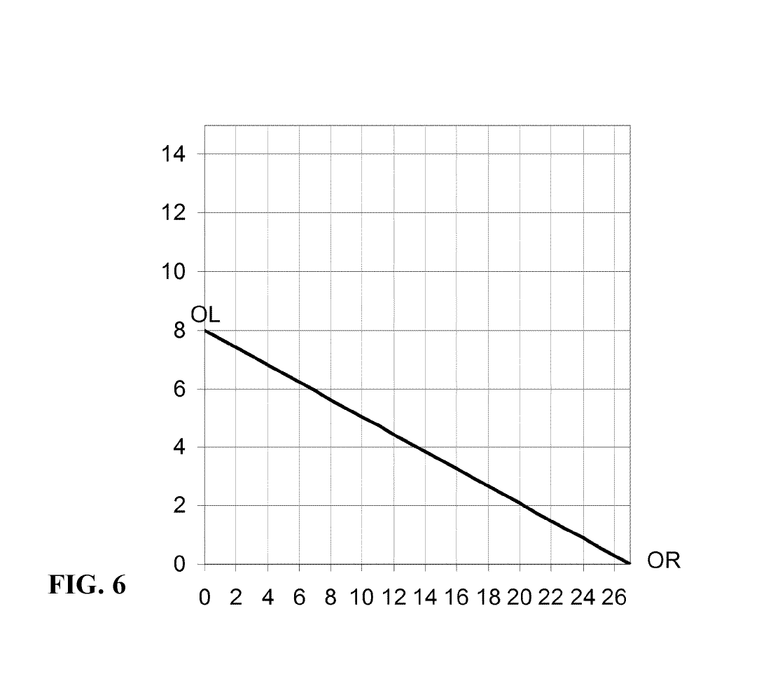

In conventional displays, each of the views is typically used to render an image corresponding to a different viewing angle. For example, a distribution of viewing angles to views may be as illustrated in FIG. 6. In the figure, the x-axis shows the view number and the y-axis show the view angle (in the example the cone cover a range from 0-8 which may be considered proportional to a total cone view angle of e.g. typically 5-20° (i.e. the example may be considered to show a cone of 8°).

The cross talk in conventional autostereoscopic multi-view displays typically results in perceptible image degradation and in some cases even discomfort to the user. Therefore, the degree of depth that is provided by an autostereoscopic multi-view display is typically reduced to relatively low levels, such as typically to only 20-30 cm relative to the display.

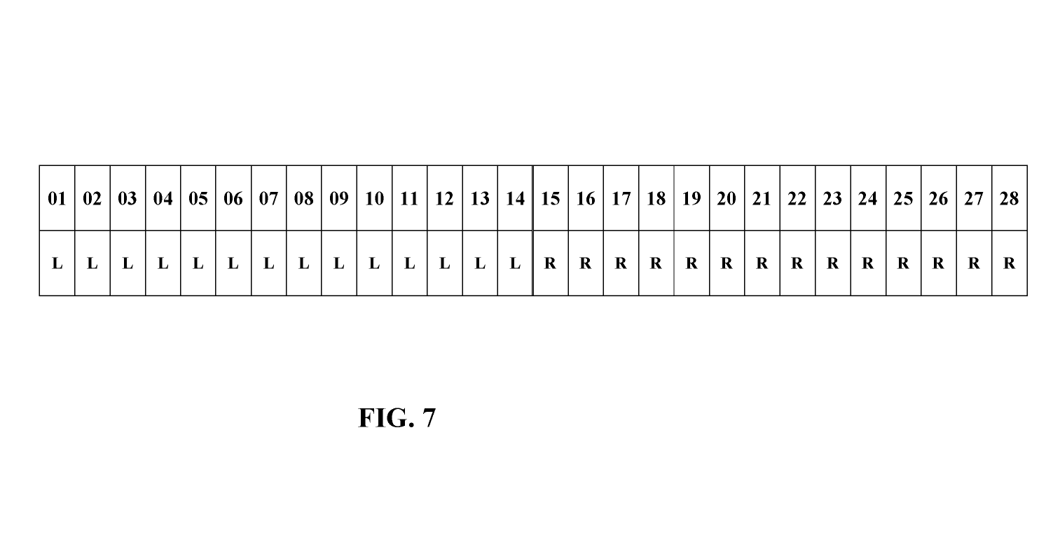

However, it has been proposed that the views of an autostereoscopic multi-view display is divided into two groups with views on one side providing a left eye image and the views on the other side providing a right eye image. Such a distribution is illustrated in FIG. 7.

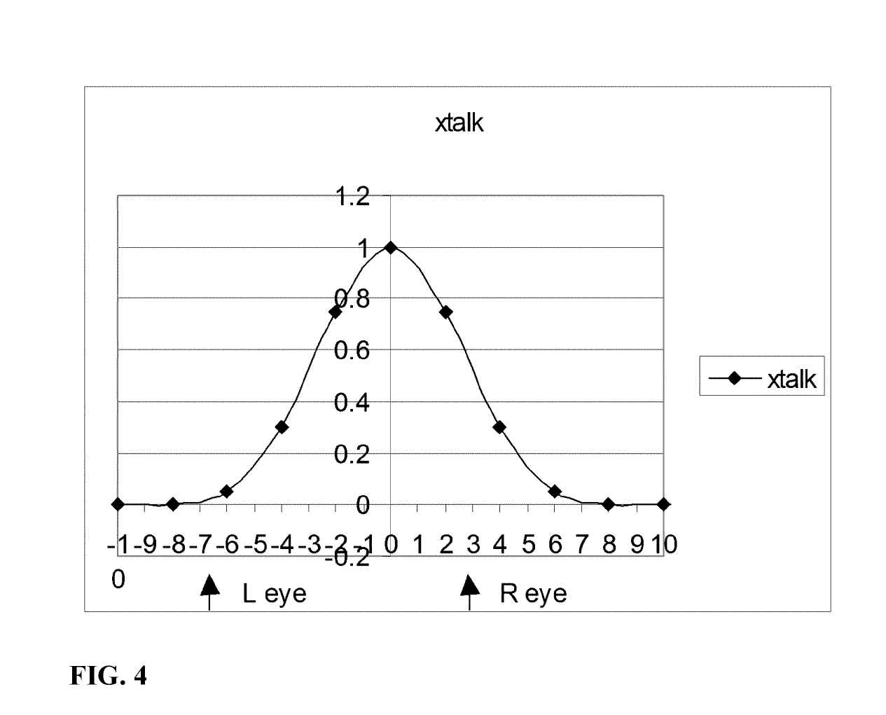

In case the display is used by a single user who is positioned at exactly the right position, i.e. with the eyes equidistant to the center of the viewing cone, this provides an improved three dimensional image as the cross talk between the individual views is reduced (as these all show the same image in one half of the viewing cone). However, some cross talk is still experienced between the different sides of the viewing cone. Thus, the right image may still be perceived by the left eye and vice versa. The effect is even more pronounced when the user is not situated exactly in the center as illustrated by FIG. 4.

This approach of using the same image in multiple views may reduce cross talk thereby allowing an increased depth effect. However, the cross talk between the different images is still significant and will typically result in at least a noticeable ghosting effect. Therefore, the depth effect will still typically be reduced.

Furthermore, reducing cross talk by e.g. not using some of the views (e.g. by some of the views being black views) results in intensity variations for even small movements of the viewer, which tends to be even more perceptible. Furthermore, using eye or face tracking to follow the movements of the user tends to be impractical due to the extreme requirements for accuracy and latency.

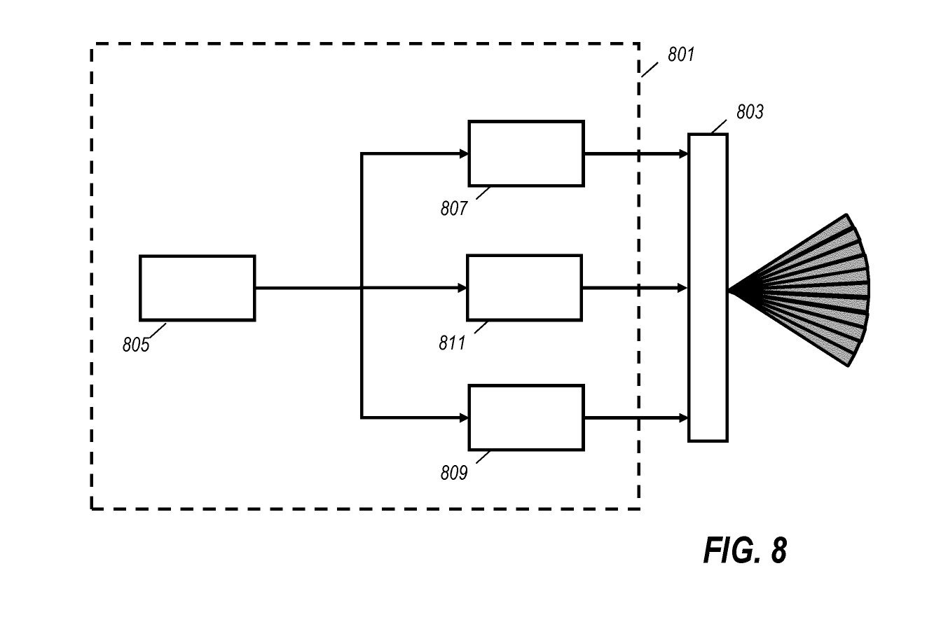

FIG. 8 illustrates an example of display in accordance with some embodiments of the invention. The display comprises an apparatus 801 for generating images for an autostereoscopic multi-view display 803.

In the example, the display is an integrated device which receives a three dimensional image (or images, e.g. from a video sequence) and which renders this (these) from a multi-view display 803. Thus, the display may in itself be considered an autostereoscopic multi-view display. It will be appreciated that in other embodiments, the functionality may be distributed, and in particular, the apparatus 801 may generate images that are fed to a separate and external autostereoscopic multi-view display.

For example, in some embodiments, the apparatus may comprise an output unit which generates and output signal comprising the first, second and third images. The output signal may then be communicated to an external and possibly remote autostereoscopic multiview display which may extract the images and render them from the appropriate views.

In the display of FIG. 8, the multiple views of the autostereoscopic multi-view display 803 are divided into (at least) three groups of contiguous views where the first group is used to render the right eye image and the second is used to render the left eye image. A third group of views is formed by one or more views that are in between the views of the first group and the second group. The views in the third group are then used to render images which correspond to (one or more) viewing angles that are in between the viewing angle of the right eye image and the viewing angle of the left eye image. Thus, the views of the third group form a transitional section between the right eye image and the left eye image and renders one or more images which corresponds to that which would be seen at one or more positions between the left eye and the right eye.

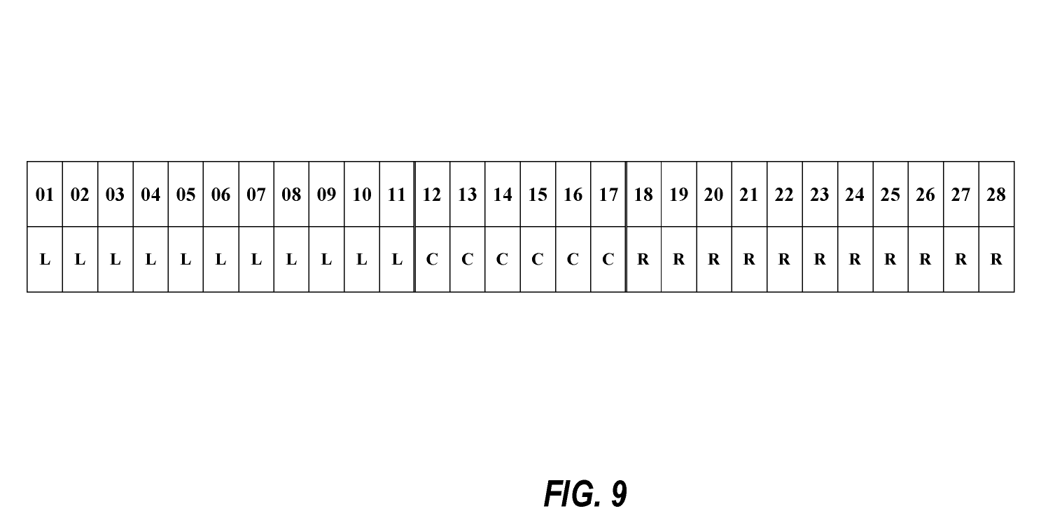

For example, the arrangement of FIG. 9 may be used. In the example, the 28 views of the multi-view display 803 are divided into three groups of contiguous views. A first group of contiguous views is formed by views 18-28. These views are used to render the right eye image, i.e. they are used to render an image generated for the right eye of the viewer. A second group of contiguous views is formed by views 01-11. These views are used to render the left eye image, i.e. they are used to render an image generated for the lift eye of the viewer. Thus, views 01-11 render an image corresponding to a viewing angle of a scene for the left eye and views 18-28 render an image corresponding to a viewing angle of a scene for the right eye. Thus, together the two groups render a three dimensional representation of a scene.

It will be appreciated that as appropriate the term “viewer” is used in accordance with conventional practice in the field and may accordingly as appropriate refer to both the physical viewer of the output of the display and to the notional viewer used as reference for generating images for the different eyes (and e.g. as the reference for the viewing angle of the images).

A third group of contiguous views is formed by views 12-17. Thus, the views of the third group of contiguous views are positioned between the views of the first group of contiguous views and the second group of contiguous views. In the example, the views of the third group of contiguous views are used to render a center image, i.e. an image which corresponds to a viewing angle of the scene which is midway between the viewing angle of the scene corresponding to the left eye and the viewing angle of the scene corresponding to the right eye. Essentially, the center view may be considered to correspond to a view that would be perceived if the user had a central eye midway between the left and right eye.

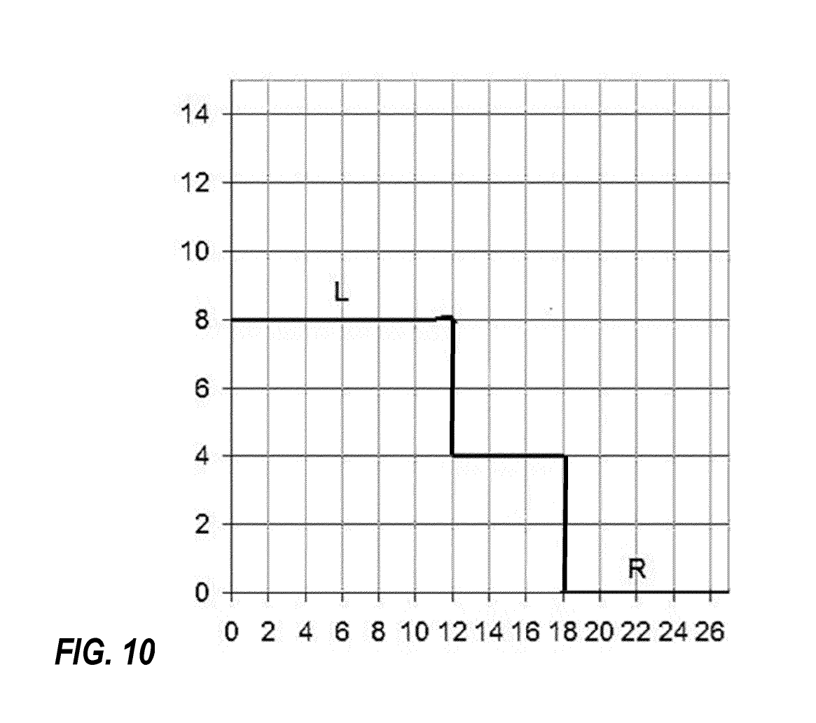

The distribution of viewing angles for the individual views is illustrated in FIG. 10.

Thus, in the example, a group of views are used as a separator or transition between the left eye views and the right eye views. The views are used to provide an intermediate image corresponding to a view in between the left and right eye views.

The apparatus of FIG. 8 specifically comprises a receiver 805 which receives three dimensional image information, such as a single three dimensional image or a 3D video sequence. The 3D images may be provided in any suitable form including as a stereo image, as a single image with depth information etc.

The receiver 805 is coupled to a first image generator 807 which generates images, referred to as first images, for views of the first group of contiguous views of the multi-view display 803. The first image generator 807 generates the images to correspond to a right eye viewing angle of the scene, i.e. the image is generated as the image which is intended to be received by the right eye. For example, if a stereo image is received by the receiver 805, the first image generator 807 may for example generate the first images to directly be the received image for the right eye. The first image generator 807 is coupled to the multi-view display 803 and the first images are provided to the appropriate views of the multi-view display 803, i.e. to views 18-28 in the specific example. All of the first images may typically be the same image, i.e. the same image is provided to views 18-28.

The receiver 805 is furthermore coupled to a second image generator 809 which generates images, referred to as second images, for views of the second group of contiguous views of the multi-view display 803. The second image generator 809 generates the images to correspond to a left eye viewing angle of the scene, i.e. the image is generated as the image which is intended to be received by the left eye. For example, if a stereo image is received by the receiver 805, the second image generator 809 may for example generate the second images to directly be the received image for the left eye. The second image generator 809 is coupled to the multi-view display 803 and the second images are provided to the appropriate views of the multi-view display 803, i.e. to views 01-11 in the specific example. All of the second images may typically be the same image, i.e. the same image is provide to views 01-11.

The receiver 805 is additionally coupled to a third image generator 811 which generates images, referred to as third images, for views of the third group of contiguous views of the multi-view display 803. The third image generator 811 generates the images to correspond to viewing angles of the scene, which are in between the viewing angles of the left eye and the right eye. In the specific example, at least one third image may be generated as a center image which corresponds to a viewing angle that is midway between the viewing angles for the left and right eyes.

The center images may for example be generated by processing one of the left and right eye images to introduce a shift of viewing angles.

Thus, in the system of FIG. 8, the multi-view display 803 is provided with three different images corresponding to three different viewing angles. A first group of contiguous views is presented with first images corresponding to an image for the right eye of the viewer, a second group of contiguous views is presented with second images corresponding to an image for the left eye of the viewer, and a third group of contiguous views is presented with third images corresponding to an image for a viewing angle midway between the right and left eyes of the viewer. Thus, each of the different groups of views is used to present an image of a scene but with different respective viewing angles, and specifically with one corresponding to the right eye, one corresponding to the left eye, and one being in between these.

Such an approach has been found to provide substantial improvements over conventional approaches. In particular, it has been found that the perceived cross talk, and in particular, the perceived ghosting effect, is substantially reduced.

Furthermore, this is achieved without introducing intensity variations that are e.g. associated with not using some views. In particular, if some views are skipped, even small head movements will cause variations in the strength of the views being perceived (or even which views are being perceived) and this will cause intensity variations that can be avoided in the current approach by using images that have corresponding intensities (and intensity distributions). Thus, intensity modulation of the picture when the view moves his head is substantially reduced thereby providing a much improved user experience.

The approach may provide a substantially increased freedom of movement of the viewer. Indeed, compared to conventional approaches where even movements of a few millimeters may cause perceptible degradations, the current approach may typically reduce the sensitivity by more than an order of magnitude. Indeed, in many scenarios, head movement of several centimeters will have little effect on the perceived image. Such an improvement may render the display system feasible for use even without dedicated viewer tracking Furthermore, it may substantially reduce the requirements imposed on viewer tracking thereby allowing and indeed in many embodiments enabling practical viewer tracking and control of the display.

The provided improvements allow a much increased depth effect to be provided without resulting in unacceptable image degradations or user discomfort.

In the example, all views of the multi-view display 803 belong to one of the first, second and third group of contiguous views, i.e. all views of the multi-view display 803 are divided into the three groups. This may provide improved performance in most scenarios, and may in particular provide the best image quality. However, in other embodiments, one or more views may not be included in one of the groups. For example, one or more of the outer views may not be used to provide separation to other view cones etc.

In many embodiments, the multi-view display 803 comprises nine or more views. Furthermore, the number of views comprised in the first and second group of contiguous views is normally three or more. Also, in most embodiments the third group of contiguous views comprises at least two, and often at least four, views.

Typically, the number of views in each group will depend on the number of views of the multi-view display 803. For example, in many embodiments, the number of views in the first and second group of contiguous views is the same, and the number of views in the third group is no less than ⅛ and no more than ¼ of the total number of views, with the remaining views being allocated to the first and second group of contiguous views.

In many embodiments, at least one, and typically both, of the first group of contiguous views and the second group of contiguous views comprise an outside view of the view cone (i.e. either the view furthest to the right or furthest to the left). Also, typically the third group of contiguous views comprises a central view.

In the example, the first images are all the same image (or possibly (different) parts of the same image). Similarly, the second images are all the same image (or possibly (different) parts of the same image). However, it will be appreciated that in many embodiments, the first and/or second images may only be substantially the same images in the sense that they may all substantially correspond to a viewing angle for the left or right eye. For example, while all first images correspond to right eye images, there may be some differences between these, e.g. they may correspond to slightly different viewing angles. Similarly, although all second images correspond to left eye images, there may be some differences between these, e.g. they may correspond to slightly different viewing angles.

It will be appreciated that the input to the apparatus may be three dimensional image information in any suitable form. It will also be appreciated that the receiver 805 may receive the image information from any suitable source including both external and internal sources.

For example, in some embodiments, the apparatus may comprise a three dimensional model for a given scene, and the images for the different views may be generated by directly evaluating the model for given viewing angles. Specifically, for a given view direction, the model may be evaluated for a viewpoint corresponding to the left eye, for a viewpoint corresponding to the right eye, and for a viewpoint there in between.

The approach is particularly suitable and advantageous for rendering of stereo images. A stereo image may provide three dimensional information by providing separate images for the left and right eyes. Thus, effectively each stereo image comprises two separate images that are simultaneous images of a scene but with different viewing angles/view points corresponding to the two eyes of a viewer.

In some embodiments, the receiver 805 may receive a stereo image and forward the right eye image to the first image generator 807 and the left eye image to the second image generator 809. The first image generator 807 may then proceed to generate the first images to correspond to the received right eye image. Indeed, it may directly use the received right eye image as the first images, or it may in some embodiments provide some processing such as e.g. noise filtering, sharpening etc. to the image before using it.

Similarly, the second image generator 809 may proceed to generate the second images to correspond to the received left eye image. Indeed, it may directly use the received left eye image as the second images, or it may in some embodiments provide some processing such as e.g. noise filtering, sharpening etc. to the image before using it.

In some embodiments, both the received right eye image and left eye image may be fed to the third image generator 811 which may proceed to generate the third image(s) by view point shifting of at least one of the left eye image and the right eye image. Thus, a view point or viewing angle shifting algorithm is applied to at least one of the right eye image and the left eye image. The viewpoint shift algorithm is arranged to shift the image towards the central position.

It will be appreciated that any suitable viewpoint shifting algorithm may be used and that many different algorithms will be known to the skilled person.

For example, as a low complexity example, the third image generator 811 may be arranged to identify individual corresponding image objects in the left eye image and right eye image. The positions of each image object in the two images may be determined, and the position in the third image may be determined as the average of the two positions (i.e. midway between the image positions in relatively the left eye image and the right eye image). For objects close to the viewer, this will result in a relatively large movement whereas it for objects in the background (or for the background) typically will result in no movement. Any remaining holes following the processing of the whole image may then be filled in using image data from one of the left eye image and the right eye image (depending on which side of the foremost image object (i.e. the image object with the largest movement) the gap is).

It will be appreciated that more complex and advanced algorithms may be used, including algorithms that utilize additional depth information or possibly occlusion layers.

The approach may in particular allow such stereo images that are typically intended for rendering using a glasses based system to be used with an autostereoscopic multi-view display. Typically, stereo images are generated to provide a very strong depth effect which is not practical with conventional autostereoscopic multi-view displays. However, the described approach may allow such a strong depth effect to be provided without introducing unacceptable image quality or discomfort. The approach may further provide for a low complexity driving of the multi-view display.

In some embodiments, the apparatus may further be arranged to adapt disparities between the left eye image and the right eye image prior to the generation of the first images, the second images and the third image. Thus, the received right eye image and left eye image may be processed to generate a modified right eye image and modified left eye image, of which one may be identical to the input image. The process described above may then be used to generate the first, second and third images based on the modified images.

The modification may specifically be such that the depth effect is changed, and typically reduced relative to the input stereo image. Thus, the three dimensional effect may be adjusted to particularly suit the actual approach and properties resulting from the rendering approach. Thus, a synergistic effect between the specific rendering approach and the adaptation of the input stereo image allows an optimized rendering of the stereo image from an autostereoscopic multi-view display.

The adapter may in particular adjust the disparity between the right eye image and the left eye image. For example, corresponding image objects may be determined. A new, say, left eye image may then be generated by moving the image objects such that the disparity (position offset or difference) between corresponding image objects is reduced to a proportion of the original disparity. E.g. the displacement may be reduced to, say, 50% of the original stereo image thereby halving the strength of the depth effect.

In some embodiments, the input image may be a mono image, i.e. the received image(s) may correspond to a single viewpoint. In addition to the image, there may be provided depth information, such as for example a depth map showing the relative depth of each pixel.

In such a scenario, the image may e.g. be provided to the third image generator 811 and directly used to generate the third image(s). Specifically, the third image may directly be generated as the received image.

Furthermore, the image and depth information may be fed to the first image generator 807 and second image generator 809 which may proceed to perform a viewpoint/viewing angle shift to shift the viewing angle for the single image. The first image generator 807 and second image generator 809 may perform the same viewing angle shift but in opposite directions.

It will be appreciated that any suitable viewpoint shift operation may be used. For example, each pixel of the input image may be shifted horizontally by a value proportional to the depth indicated for the pixel in the depth map. The shift for the first and second images are in the opposite directions. Any resulting holes may be filed in by extrapolation from the neighbor region furthest back, or may e.g. be filed in by occlusion data provided in addition to the input image.

In the previous example, the third group of contiguous views were used to present a single image corresponding to a center image. However, in other embodiments or scenarios other images may be generated and used. Furthermore, different images may be used for different views of the group of contiguous views. However, in most embodiments all of the views of the third group of contiguous views will comprise images of the scene corresponding to a viewing angle between the left and right eye viewing angles. This will provide improved image quality and specifically reduced cross talk thereby allowing e.g. increased depth effect.

Thus, whereas in the previous examples, the third image generator 811 was arranged to generate images for the plurality of views of the third group of contiguous views as at least part of one image, the third image generator 811 may in other embodiments generate different images for different views of the third group of contiguous views, e.g. corresponding to different viewing angles between the right eye viewing angle and the left eye viewing angle.

The viewing angles for the images in the third group of contiguous views may specifically gradually change from being closer to the right eye viewing angle to closer to the left eye viewing angle. Thus, the images used for the third contiguous group may correspond to viewing angles that are intermediate between the left eye viewing angle and the right eye viewing angle but with a monotonic increase (or decrease) of the viewing angle. Thus, in order of right to left, the viewing angle changes gradually in the direction from the right eye viewing angle to the left eye viewing angle. Thus, a viewing angle for a view further to the left than another view of the third group of contiguous views will be the same or to the left than the viewing angle for this other view.

Thus, in many embodiments, the third image generator 811 advantageously generates images for the plurality of views of the third contiguous group to correspond to viewing angles that have a monotonic relationship to a distance of the views to the first group of contiguous views. E.g. the further the individual view is separated (in terms of views) from the views providing a right eye view, the further the viewing angle is from the right eye viewing angle.

Equivalently, in many embodiments, the third image generator 811 advantageously generates images for the plurality of views of the third contiguous group to correspond to viewing angles that have a monotonic relationship to a distance of the views to the second group of contiguous views. E.g. the further the individual view is separated (in terms of views) from the views providing a left eye view, the further the viewing angle is from the left eye viewing angle.

In many embodiments, the viewing angles may specifically change linearly as a function of the distance to the first and/or second group of contiguous views.

For example, in an embodiment, the separating or transitional views of the group of contiguous views may be provided with images that are all different and which correspond to viewing angles that depend on the relative position of the view to the first or second contiguous groups, and/or to the center of the viewing cone. For example, the third image generator 811 may use viewing angle shifting algorithms to synthesize images that correspond to viewing angles that change linearly. Specifically, instead of using central images as described in the previous example, the third image generator 811 may synthesize the following images:

View 13: synthetic image/view at 20%/80% in between L and R

View 14: synthetic image/view at 40%/60% in between L and R

View 15: synthetic image/view at 60%/40% in between L and R

View 16: synthetic image/view at 80%/20% in between L and R

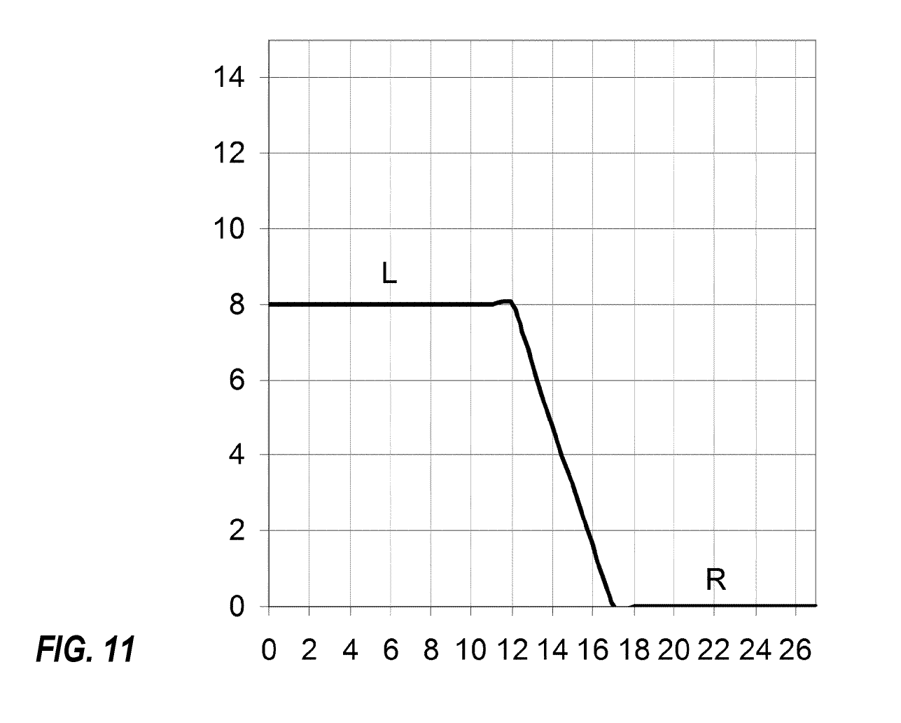

The example is illustrated in FIG. 11.

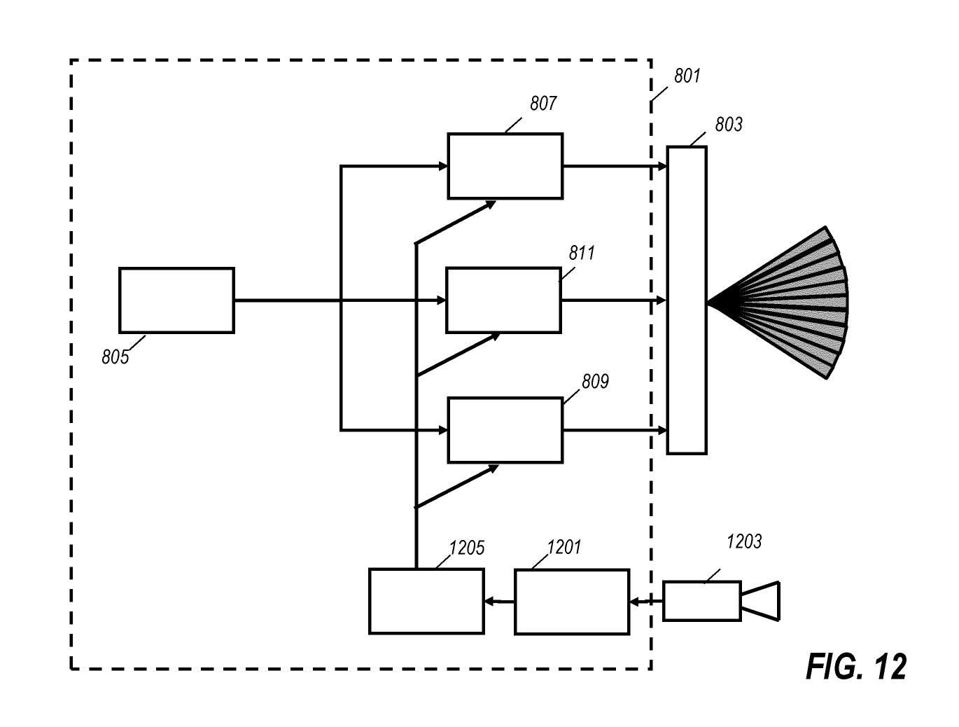

In some embodiments, the apparatus may as illustrated in FIG. 12 furthermore comprise a viewer position tracking unit 1201 which is arranged to generate a user viewing angle estimate (the user viewing angle being indicative of the angle from the user to the display). The viewer position tracking unit 1201 may for example receive an input from an external sensor 1203, such as one or more cameras. The viewer position tracking unit 1201 may for example use eye detection to estimate a position of the user relative to the display as will be well known to the skilled person.

The viewer position tracking unit 1201 is coupled to an adaptor 1205 which is arranged to adapt the viewing cone formed by the first group of contiguous views, the second group of contiguous views, and the third group of contiguous views in response to the viewer viewing angle.

For example, if the user moves a to the left such that his eyes are no longer central to the border between views 14 and 15 but rather between views 13 and 14, the adaptor 1205 may change the generation of images such that the entire viewing cone is effectively shifted such that the center of the viewing cone is now central on the new position. Thus, the views of the multi-view display 803 which previously corresponded to views 13 and 14 of the viewing cone are now reallocated to be views 14 and 15 of the viewing cone. Thus, effectively the viewing cones that are generated by the multi-view display 803 are effectively shifted one view to the left thereby following the user and keeping the user central in the viewing cone.

It will be appreciated that the viewing cone can also be shifted by less than a whole view distance. Specifically, the images can be shifted by less than a pixel size by performing spatially interpolative filtering on the images corresponding to a spatial shifts of less than a pixel.

Specifically, the allocation of the three different images to the viewing angles shown in FIG. 9 assumes the eyes of the viewer are exactly in the center of the viewing cone of the autostereoscopic display.

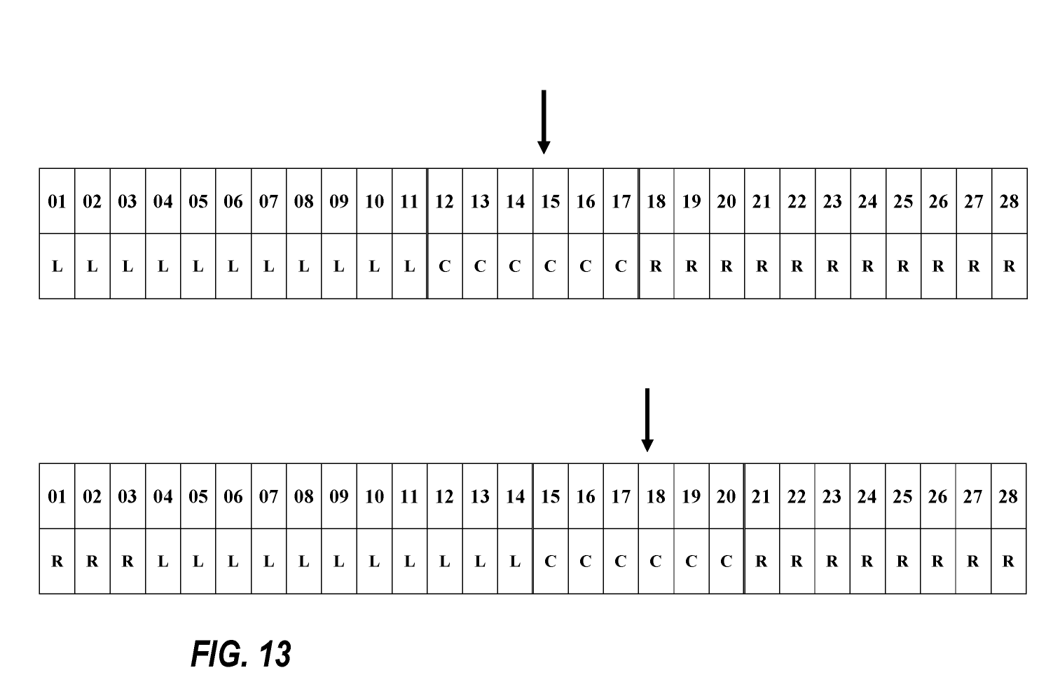

This corresponds to the upper example of FIG. 13 where indeed the viewer position tracking unit 1201 has identified that the eyes of the viewer are exactly in the center of the cone and the adaptor 1205 accordingly has controlled the first image generator 807, the second image generator 809, and the third image generator 811 to generate the images for the views as shown.

However when the user is not exactly in the center, all the individual viewing angles are cyclically shifted over the available angles i.e. over the 28 views. This is illustrated in the lower example of FIG. 13 for an example where the viewer position tracking unit 1201 has identified that the center of the eyes of the viewer are at the specific position corresponding to the border between views 17 and 18. Thus, in this way the effective direction/center of each viewing cone formed by the display is adapted in response to the user viewing angle estimate.

Thus, the user movement is tracked and the allocation of the views to the different groups of contiguous views is made dependent on the user viewing angle estimate. Indeed, in some embodiments the adaptor 1205 may be arranged to allocate each view of the views of the autostereoscopic multiview display to the first contiguous group of views, the second contiguous group of views, or the third contiguous group of views in response to the viewing angle estimate.

The use of the transitional views of the third group of contiguous views has been found to allow a much reduced accuracy of the tracking of the viewer position. Indeed, rather than requiring real time tracking in the order of a few millimeters, it has been found that the approach provides comparable quality using viewer position trackers with an accuracy of only a few centimeters. This may accordingly allow viewer estimation with substantially reduced requirements for accuracy (and consequently) latency. Indeed, the system allows autostereoscopic displays to be based on viewer position tracking without introducing impractical and typically infeasible complex and expensive tracking systems.

The previous examples have focused on scenarios wherein each view provided the full image. However, in some embodiments, one or more views may provide only partial images. This means that one specific viewing angle (e.g. view 06) will not contain all the pixels to fill the entire screen area. However when a partial image in a specific viewing angle (e.g. 06) is combined with neighbor viewing angles (e.g. 05 & 07), then the entire screen area will be covered.

For example, in the example of FIGS. 9 and 10 wherein the six images of the third group of contiguous views are generated to correspond to the same viewing angle, each view may only provide e.g. a third of the full image in each view. For example, one view may correspond to one area, the next view to a different area, the third view to yet another area, the fourth view to the first area again etc. The user will typically simultaneously perceive a plurality of views and therefore the perception of the full image will be achieved by a combination of the individual views. Such an approach may provide an improved resolution as the pixels for each view need only support a smaller area.

It will be appreciated that the same approach may be applied to the images for the view of the third group of contiguous views even if these do not correspond to the same viewing angle. Also, the approach may be used for the views in the first and second group of contiguous views.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An apparatus for generating images for an autosteroscopic multi-view display arranged to display a plurality of views; the apparatus comprising:
a first image generator for generating first images for views of a first group of contiguous views of the plurality of views, the first images corresponding to a right eye viewing angle;
a second image generator for generating second images for views of a second group of contiguous views of the plurality of views, the second images corresponding to a left eye viewing angle; and
a third image generator for generating a third image for at least one view of a third group of contiguous views of the plurality of views, the third group of contiguous views comprising views between the first group of contiguous views and the second group of contiguous views;
wherein the third image corresponds to a viewing angle which is between the right eye viewing angle and the left eye viewing angle.

2. The apparatus of claim 1 further comprising a receiver arranged to receive a three dimensional image,
wherein the first image generator is arranged to generate the first images from the three dimensional image,
wherein the second image generator is arranged to generate the second images from the three dimensional image,
wherein the third image generator is arranged to generate the third image from the three dimensional image.

3. The apparatus of claim 2,
wherein the three dimensional image is a stereo image comprising a left eye image and a right eye image
wherein the first image generator is arranged to generate the first images to correspond to the right eye image,
wherein the second image generator is arranged to generate the second images to correspond to the left eye image,
wherein the third image generator is arranged to generate the third image by view point shifting applied to at least one of the left eye image and the right eye image.

4. The apparatus of claim 3 further comprising a disparity adapter arranged to adapt disparities between the left eye image and the right eye image prior to the generation of the first images, the second images and the third image.

5. The apparatus of claim 2 wherein the three dimensional image is a single viewpoint image with associated depth information
wherein the first image generator is arranged to generate the first images by view point shifting of the single viewpoint image based on the associated depth information,
wherein the second image generator is arranged to generate the second images by view point shifting of the single viewpoint image based on the associated depth information,
wherein the view point shifting of the second images is in an opposite direction of the view point shifting of the first images;
wherein the third image generator is arranged to generate the third image to correspond to the single viewpoint image.

6. The apparatus of claim 1 wherein the third group of contiguous views comprises a plurality of views, and the third image generator is arranged to generate images for all views of the third group of contiguous views to correspond to third viewing angles, wherein the third viewing angles are between the right eye viewing angle and the left eye viewing angle.

7. The apparatus of claim 6 wherein the third image generator is arranged to generate images for the plurality of views of the third group of contiguous views as at least part of the third image.

8. The apparatus of claim 6 wherein the third image generator is arranged to generate images for the plurality of views of the third contiguous group to correspond to the third viewing angles, wherein the third viewing angels have having a monotonic relationship to a distance of the views to the first group of contiguous views.

9. The apparatus of claim 8 wherein the relationship is a linear relationship.

10. The apparatus of claim 1 further comprising:
a viewer position tracking unit arranged to generate a user viewing angle estimate; and
an adaptor arranged to adapt a direction of at least one viewing cone formed by the plurality of views in response to the user viewing angle estimate.

11. The apparatus of claim 1 wherein all views of the plurality of views of the multi view display belong to one of the first group of contiguous views, the second group of contiguous views, and the third group of contiguous views.

12. The apparatus of claim 1 wherein the third image generator is arranged to generate different partial images for at least some views of the third group of contiguous views.

13. An autosteroscopic multi-view display arranged to display a plurality of views, the autosteroscopic multi-view display comprising:
a first image generator arranged to generate first images for views of a first group of contiguous views of the plurality of views, wherein the first images correspond to a right eye viewing angle;
a second image generator arranged to generate second images for views of a second group of contiguous views of the plurality of views, wherein the second images correspond to a left eye viewing angle;
a third image generator arranged to generate a third image for at least one view of a third group of contiguous views of the plurality of views, wherein the third group of contiguous views comprise views between the first group of contiguous views and the second group of contiguous views;
wherein the third image corresponds to a viewing angle which is between the right eye viewing angle and the left eye viewing angle.

14. A method of generating images for an autosteroscopic multi-view display comprising:
generating first images for views of a first group of contiguous views of the plurality of views, wherein the first images correspond to a right eye viewing angle;
generating second images for views of a second group of contiguous views of the plurality of views, wherein the second images correspond to a left eye viewing angle;
generating a third image for at least one view of a third group of contiguous views of the plurality of views, wherein the third group of contiguous views comprise views between the first group of contiguous views and the second group of contiguous views;
wherein the third image corresponds to a viewing angle which is between the right eye viewing angle and the left eye viewing angle.

15. A computer program product comprising computer program code adapted to perform the steps of the method comprising:
generating first images for views of a first group of contiguous views of the plurality of views, wherein the first images correspond to a right eye viewing angle;
generating second images for views of a second group of contiguous views of the plurality of views, wherein the second images correspond to a left eye viewing angle;
generating a third image for at least one view of a third group of contiguous views of the plurality of views, wherein the third group of contiguous views comprise views between the first group of contiguous views and the second group of contiguous views;
wherein the third image corresponds to a viewing angle which is between the right eye viewing angle and the left eye viewing angle.

16. The method of claim 14 further comprising a receiver arranged to receive a three dimensional image,
wherein the first images are generated from the first images of the three dimensional image,
wherein the second images are generated from the three dimensional image,
wherein the third image is generated from the three dimensional image.

17. The method of claim 16,
wherein the three dimensional image is a stereo image comprising a left eye image and a right eye image,
wherein the first images correspond to the right eye image,
wherein the second images correspond to the left eye image,
wherein the third images are generated by view point shifting applied to at least one of the left eye image and the right eye image.

18. The method of claim 17 further comprising adapting disparities between the left eye image and the right eye image prior to the generation of the first images, the second images and the third image.

19. The method of claim 14 wherein the three dimensional image is a single viewpoint image with associated depth information,
wherein the first images are generated by view point shifting of the single viewpoint image based on the associated depth information,
wherein the second images are generated by view point shifting of the single viewpoint image based on the associated depth information,
wherein the view point shifting of the second images is in an opposite direction of the view point shifting of the first images,
wherein the third images are generated to correspond to the single viewpoint image.

20. The method of claim 14 wherein the third group of contiguous views comprises a plurality of views, and the third images are generated for all views of the third group of contiguous views to correspond to third viewing angles, wherein the third viewing angles are between the right eye viewing angle and the left eye viewing angle.
